(19) United States
(12) Patent Application Publication
(10) Pub. No.: US 2025/0140100 A1
(43) Pub. Date: May 1, 2025

(54) USING MACHINE-LEARNING MODELS TO PROTECT VEHICLES

(71) Applicant: Vivint, Inc., Provo, UT (US)

(72) Inventors: Erik Stephen Pfeiffer, Provo, UT (US); Michelle Bea Zundel, Provo, UT (US)

(73) Assignee: Vivint, Inc., Provo, UT (US)

(21) Appl. No.: 18/922,880

(22) Filed: Oct. 22, 2024

Related U.S. Application Data
(60) Provisional application No. 63/593,091, filed on Oct. 25, 2023.

(51) Int. Cl. G08B 21/22; G06T 7/20; G06T 7/70; G08B 3/10; G08B 5/22

(52) U.S. Cl. CPC G08B 21/22; G06T 7/20; G06T 7/70; G08B 3/10; G08B 5/22; G06T 2207/30196; G06T 2207/30241; G06T 2207/30252

(57) ABSTRACT

A method may include detecting, by a computer executing a machine-learning model, a vehicle located within an area, detecting, by the computer executing the machine-learning model, a person approaching the vehicle, and, in response to the person approaching the vehicle, executing, by the computer executing the machine-learning model, a deterrence action.

### CROSS REFERENCE

This application claims priority to U.S. Provisional Patent Application, 63/593,091, filed Oct. 25, 2023, and entitled USING MACHINE-LEARNING MODELS TO PROTECT VEHICLES, which is incorporated by reference herein in its entirety.

### TECHNICAL FIELD

This application generally relates to security systems, specifically security systems which use cameras and other sensors to monitor activity.

### BACKGROUND

Cameras are widely used to monitor premises for security reasons. However, camera footage captured by a camera but not viewed by a user cannot be used by the user to prevent harmful activities. As an example, a homeowner cannot practically constantly monitor their security camera feeds to identify and prevent vehicle-related theft or damage.

### BRIEF DESCRIPTION OF THE DRAWINGS

The accompanying drawings constitute a part of this specification, illustrate various embodiments, and, together with the specification, explain the subject matter of the disclosure.

FIG. 1 illustrates an example system, according to an embodiment.

FIG. 2 is a flow diagram illustrating operations of a method for identifying and deterring vehicle-related theft and damage, according to an embodiment.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Disclosed herein are systems and methods for identifying and deterring theft and damage to vehicles. Various sensors may be used as input for a machine-learning model which identifies a vehicle in an area. In an example, a camera provides video for the machine-learning model to identify a vehicle in a driveway. The machine-learning model may detect a person approaching the vehicle, such as a person attempting to steal items from the vehicle. The machine-learning model may, in response to the person approaching the vehicle, execute a deterrence action. In an example, the machine-learning model causes the camera to emit light and/or sound to deter a person from approaching the vehicle and/or stealing items from the vehicle.

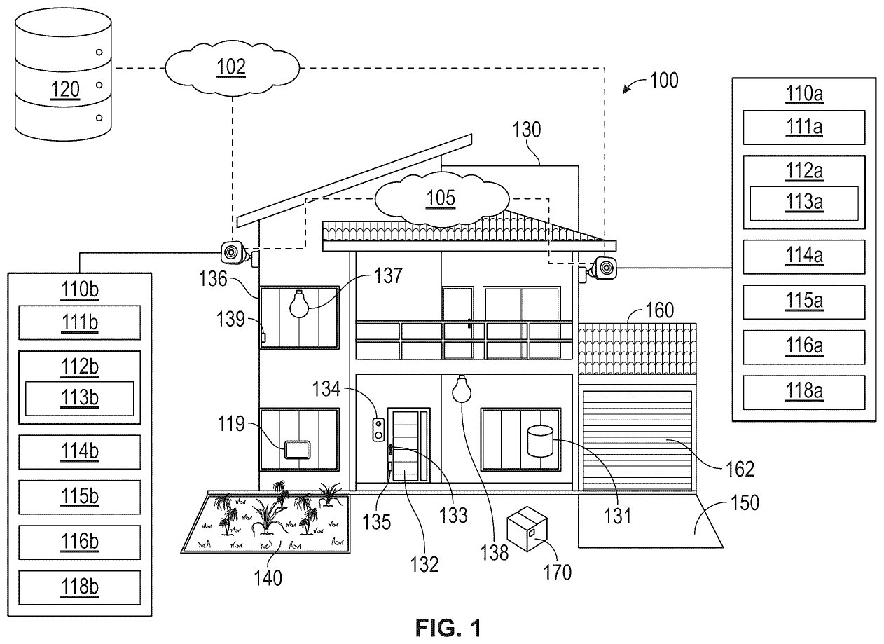

FIG. 1 illustrates an example environment 100 in which the present systems and methods may be implemented. The environment 100 may include a site that can include one or more structures, any of which can be a building 130 such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property or building. In an example, the environment includes a cul-de-sac including multiple homes.

The environment 100 may include a first camera 110a and a second camera 110b, referred to herein collectively as cameras 110. The cameras 110 may be attached to the building 130. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a one or more cameras associated with one or more buildings. The cameras 110 may share data with the server 120 for training the AI models 113 and/or one or more other AI models. The AI models 113 may be trained using both data from the server 120 and data from their respective cameras. The AI models may be machine-learning models including neural networks, state-vector machines (SVMs), recurrent neural networks, and other types of machine-learning models.

The cameras 110, in some implementations, may determine a likelihood that the object 170 (e.g., a package) is within an area (e.g., a portion of a site or of the environment 100). In some embodiments, the identification of the object 170 as within the area may be based, at least in part, on audio data from microphones 118, using sound analytics and/or the AI models 113. In some implementations, the cameras 110 may determine a likelihood that the object 170 is within an area based, at least in part, on image data using image processing, image detection, and/or the AI models 113. The cameras 110 may determine a likelihood that an object is within an area based, at least in part, on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114. As used herein, “depth data” refers to distance from the camera, or depth-of-field, giving “depth” to the image data when the radar or depth data are correlated with the image data.

In some embodiments, the area may be defined as a complete field of view of the corresponding camera 110. In other embodiments, the area may be pre-defined as a subsection of the field of view of the corresponding camera 110. The pre-definition of the area may be set as a default. In some embodiments, the area may be selected and/or set. For example, a user may define the area within the field of view of the camera. The user may define the area by dragging boundaries or points within a visual representation of the field of view of the cameras 110, or other sensors. In another embodiments, the user may select areas by clicking, tapping, or otherwise selecting the area generally resulting in an intelligent analysis and selection of the area. In some embodiments, the user may select from one or more pre-determined areas suggested to the user. The user may select and apply or modify a pre-determined area.

In other embodiments, the area may be determined without input from a user. For example, the AI model 113 may analyze the field of view of one or more of the cameras 110 and identify one or more portions of the field of view to designate as one or more areas to monitor. In some embodiments, the AI model 113 may identify the area based on data gathered over time, by an analysis of the field of view of the one or more cameras 110 and/or based on training data corresponding to environments having correlated aspects or characteristics for setting the area.

In some embodiments, the cameras 110 may provide overlapping fields of view. In some example, one or more areas may be defined within an overlapping portion of the fields of view of the cameras 110. One or more other areas may be defined which correspond to a field of view of one of the cameras 110 and not a field of view of another of the cameras 110. In some embodiments, the cameras 110 may generate a composite view of an area corresponding to two or more of the cameras 110. The area may be defined using a field of view of one of the cameras 110 and transposed to at least one other of the cameras 110 containing at least a portion of the defined area.

The environment 100 may include a user interface 119. The user interface 119 may be part of a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116. One or more sounds may be selected from one or more stored sounds (e.g., stored on memory 112, the server 120, or at another resource or asset. In some embodiments, the user may speak and have the spoken sound communicated directly to one or more speakers 116 associated with one or more of the cameras 110 or separate from the one or more cameras 110.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine-learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area). For example, the cameras 110 and/or each of the cameras 110 may use a voting algorithm or implement a weighting protocol or other methodology to determine that the object 170 is present within an area in response to a majority of sensors of the cameras and/or of each of the cameras determining that the object 170 is present within the area. In some implementations, the cameras 110 may determine that the object 170 is present within an area in response to on, some, or all sensors determining that the object 170 is present within the area (e.g., a more conservative and/or less aggressive determination than a voting algorithm). For example, an object may be confirmed if more sensors agree than disagree or if two or more sensors agree. In some implementations, the cameras 110 may determine that the object 170 is present within an area in response to at least one sensor determining that the object 170 is present within the area (e.g., a less conservative and/or more aggressive determination than a voting algorithm).

In some implementations, the cameras 110 may include gyroscopes and/or accelerometers to determine an orientation of the cameras 110. The cameras 110 may take into account their orientation and combine their orientation with other data. In an example, a camera may determine that it is pointed straight down, adjusting its interpretation of image data and radar data accordingly. In this way, an accuracy of the determinations made by the cameras 110 and their AI models 113 may be improved, as views of objects and persons may be different from different angles.

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the cameras 110 may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 101. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human is, has, intends to, and/or may otherwise perform one or more suspicious acts, is unknown/unrecognized, has entered a restricted area/zone such as the first region of interest 140 or the second region of interest 150, the cameras 110 may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the cameras 110 are configured to play and/or otherwise emit one or more sounds in response to detecting the presence of a human within an area. For example, the cameras 110 may play one or more sounds selected to deter a detected person from an area around a property/building 101 and/or object. The cameras 110, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The cameras 110, in some implementations, stores and/or has access to a library comprising a plurality of different sounds and/or a set of dynamically generated sounds so that the controller 106 may vary the different sounds over time, not using the same sound often. In some embodiments, varying and/or layering sounds allows a deter sound to be more realistic and/or less predictable. One or more of the sounds may be selected to give a perception of human presence in the building 101, a perception of a human talking over an electronic speaker device, or the like which may be effective at preventing crime and/or property damage.

For example, a library and/or other set of sounds may include audio recordings and/or dynamically generated sounds of one or more, male and/or female voices saying different phrases, such as for example, a female saying “hello?”, a female and male together saying “can we help you?”, a male with a gruff voice saying, “get off my property” and then a female saying “what's going on?”, a female with a country accent saying “hello there”, a dog barking, a teenager saying “don't you know you're on camera?”, and/or a man shouting “hey!” or “hey you!”, or the like.

In some implementations, the cameras 110 may dynamically generate one or more sounds (e.g., using machine-learning and/or other artificial intelligence, or the like) with one or more attributes that vary from a previously played sound. For example, the cameras 110 may generate sounds with different verbal tones, verbal emotions, verbal emphases, verbal pitches, verbal cadences, verbal accents, or the like so that the sounds are said in different ways, even if they include some or all of the same words. In some embodiments, the cameras 110 and/or a remote computer 125 may train machine-learning on reactions of previously detected humans in other areas to different sounds and/or sound combinations (e.g., improving sound selection and/or generation over time).

The cameras 110 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The cameras 110, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the cameras 110 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the cameras 110 may play a primary sound layered and/or overlapping with one or more secondary, tertiary, and/or background sounds, varying the sounds and/or the combination from one or more previously played sounds and/or combinations, or the like.

The cameras 110, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The cameras 110, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the cameras 110 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the cameras 110 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120, may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data. For example, the AI models 113 may be trained using training data that may include one or more images of the object to be identified, validation data to validate the operation of the AI models 113, key performance indicators (KPI) or other test/evaluation data to assess the capability of the AI models 113 to identify an object in the field of view of one or more of the cameras 110.

In some implementations, the cameras 110 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

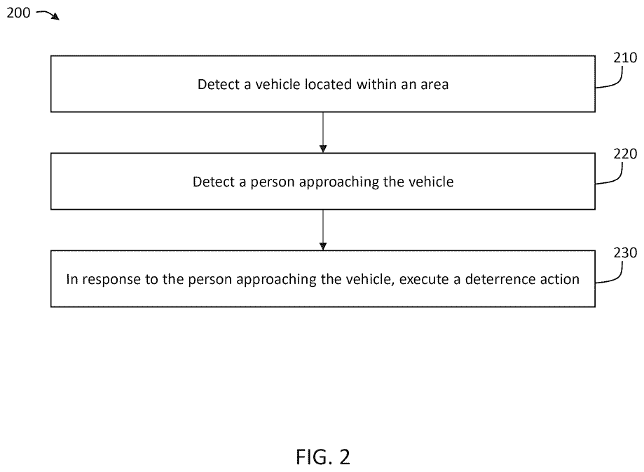

FIG. 2 is a flow diagram illustrating operations of a method for identifying and deterring vehicle-related theft and damage. The method 200 may include additional, fewer, or different operations than shown. The operations may be performed in the order shown, concurrently, or in a different order. The method 200 may be performed by one or more components of the environment 100. For example, the method 200 may be performed by the first camera 110a, the second camera 110b, or the cameras 110.

A vehicle located within an area is detected 210. In some embodiments, image processing may be utilized to detect or otherwise identify 210 the vehicle within a field of view of a camera 110 or image data captured therefrom. In some embodiments, a machine-learning model may be trained and utilized to detect or otherwise identify 210 the vehicle. The area may be a predefined area, such as the first region of interest 140 or the second region of interest 150 of FIG. 1. The area may be defined by user input. In an example, a user provides user input at a user interface to define the area as a portion of a property or a portion of a field of view of a camera. In an example, the machine-learning model provides a suggested area to the user for approval and/or modification. In an example, the area is a portion of a street in front of a house or a driveway of the house. In an example, the area is a parking lot associated with a building. The area may be learned by the machine-learning model. The area may be a portion of a street in front of a house where a vehicle is commonly parked or a portion of a driveway where a vehicle is commonly parked. In an example, the machine-learning model defines the area based on the area being a location where a vehicle is most frequently parked. The machine-learning model may be trained using historical data and/or user input to learn the area and/or detect the vehicle within the area. In an example, user input may include a user indicating in an image their parked car and/or a parking space for their car. In some embodiments, the area may be defined as a region surrounding a vehicle determined to be parked within the field of view/detection of a camera or other sensor.

Detecting the vehicle within the area may include tracking the vehicle entering the area. In an example, detecting the vehicle within the area may include detecting the vehicle on a street and determining that the vehicle is entering the area. In an example, detecting the vehicle within the area may include determining that the vehicle has stopped within the area and/or within a portion of the area associated with a parking space. In an example, detecting the vehicle within the area includes detecting the vehicle passing through the area and stopping within the area. In an example, detecting the vehicle within the area includes detecting an object within the area and determining that the object is a vehicle. In an example, detecting the vehicle within the area includes detecting an object entering the area and can include inferring based on a velocity of the object that the object is a vehicle.

Detecting the vehicle within the area may include determining that the vehicle is parked. Determining that the vehicle is parked may include determining a location and/or orientation of the vehicle. Determining that the vehicle is parked may include detecting a parking space. In an example, detecting the vehicle within the area may include determining that the vehicle is located on a shoulder of a street. In an example, detecting the vehicle within the area may include determining that the vehicle is within a marked parking space. In an example, detecting the vehicle within the area may include determining that the vehicle is within a carport or garage.

Detecting the vehicle within the area may include determining a state of the vehicle. The state of the vehicle may include whether the vehicle is running, whether a door or window of the vehicle is open, damage to the vehicle, leaks from the vehicle, tire pressure of tires of the vehicle, and other parameters of the vehicle. The state of the vehicle may be used to initiate and/or escalate deterrence actions and/or to generate notifications to a user. In an example, a vehicle left running may result in a notification being sent to the user that they left their vehicle running. In an example, a door left open may result in a notification being sent to the user that they left their door open, an expanded perimeter for deterrence actions, and/or an escalated response to a person approaching the vehicle. Data from various sensors may be used to determine the state of the vehicle. In an example, image data and/or radar may be used to determine that the door of the vehicle is left open. In an example, radar data corresponding to vibrations of the vehicle may be used to determine that the vehicle is left running.

Detecting the vehicle may include identifying the vehicle. In some implementations, identifying the vehicle may include determining a color, make, model and/or year of the vehicle. In some implementations, identifying the vehicle may include reading a license plate of the vehicle. In some implementations, identifying the vehicle may include determining ownership of the vehicle and/or determining an owner associated with the vehicle. In an example, the machine-learning model may identify a vehicle as “Matt's car.” Determining ownership of the vehicle may include comparing characteristics of the vehicle to characteristics of vehicles associated with vehicle owners. The machine-learning model may set different levels of security response and/or execute different deterrence actions based on the identity of the vehicle. The machine-learning model may be trained using historical data and/or user input to identify the vehicle. In an example, the machine learning model may be trained using pictures of various different colors, makes, models, and years of vehicles to identify different vehicles. In an example, a user may identify their vehicle and/or vehicles belonging to friends and family in image data.

Detecting the vehicle within the area may include determining a location of the vehicle using multiple sensors. Data from the multiple sensors may be correlated to determine the location of the vehicle. In an example, image data may be correlated with radar data to determine the location of the vehicle. In an example, audio data may be correlated with image data and/or radar data to determine the location of the vehicle. In an example, image and radar data may be correlated to determine the location of the vehicle, and audio data may be correlated with the image and radar data to determine when the vehicle is parked, when a person gets out of the vehicle, and/or when a door of the vehicle is closed. Determining the location of the vehicle may include logging the location of the vehicle within the area. In an example, points within a coordinate plane corresponding to the location of the vehicle may be recorded for comparison against locations of buildings, boundaries of the area, and/or locations of persons. In an example, points within a virtual model of the area and/or surroundings corresponding to the location of the vehicle may be recorded for comparison against locations of buildings, boundaries of the area, and/or locations of persons. A perimeter may be established around the vehicle for determining whether a person approaches the vehicle. In some implementations, multiple nested perimeters may be used to determine whether a person approaches the vehicle and/or whether a person is interacting with the vehicle.

A person approaching the vehicle is detected 220. In some embodiments, image processing may be utilized to detect or otherwise identify 220 the person approaching the vehicle within a field of view of a camera 110 or image data captured therefrom. In some embodiments, a machine-learning model may be trained and utilized to detect or otherwise identify 220 the person approaching the vehicle. The machine-learning model may detect the person approaching the vehicle based on a position and velocity of the person relative to the vehicle. In an example, a camera executing a machine-learning model may determine a position and velocity of a person to determine that a person is approaching the vehicle. In an example, a camera executing a machine-learning model may determine a position and velocity of a person to determine that a person is walking past the vehicle. In some implementations, the position and/or velocity of the person may be compared to one or more thresholds relative to the vehicle. The one or more thresholds may be any shape and may correspond to potential action a person might take relative to the vehicle. In an example, a threshold may be farther away from the vehicle along the sides of the vehicle than in front of and/or behind of the vehicle, corresponding to a potential action of trying the doors of the vehicle and/or breaking side windows of the vehicle.

Detecting the person approaching the vehicle may include determining one or more characteristics and/or actions of the person. Determining the one or more characteristics of the person may include determining clothing, height, girth, weight, hair color, gait, category, profession, identity, carried objects, and other characteristics. In an example, a camera executing a machine-learning model may determine that a person is wearing jeans and a red t-shirt. In an example, a camera executing a machine-learning model may determine that a person is a mail carrier or package delivery driver. In an example, a camera executing a machine-learning model may determine that a person is a child. In an example, a camera executing a machine-learning model may determine a person's identity using facial recognition and/or other characteristics. In an example, the machine-learning model may compare the person's identity to a list of persons known to engage in theft in the neighborhood, city, region, or state where the vehicle is located. In an example, the machine-learning model may identify known persons who are authorized to use the vehicle.

Detecting the person approaching the vehicle may include determining that the one or more characteristics and/or actions of the person are indicative of theft, or an intent to commit theft. For example, the one or more characteristics may be checked against a list, matrix, map, or other data structure correlating the one or more characteristics and/or actions of the person to a likelihood of undesirable outcomes. The one or more characteristics may be used to create a composited likelihood/probability of an undesirable outcome through weighting, scoring, or other compositional methodologies. In some implementations, carried objects, such as tools for breaking into vehicles and/or bags or sacks may be indicative of theft. In some implementations, actions such as peering into car windows or lingering near the vehicle for a predetermined amount of time may be indicative of theft. In some implementations, a combination of one or more characteristics and/or actions may be indicative of theft. In an example, carrying a tool for breaking car windows may be indicative of theft. In an example, walking slowly past the vehicle while looking in the windows of the vehicle may be indicative of theft. The machine-learning model may determine a type of theft indicated by the one or more characteristics and/or actions of the person. The machine-learning model may determine a probability or likelihood of one or more types of theft. In an example, the machine-learning model may determine that there is a 20% chance of the vehicle being stolen and a 30% chance of items from the vehicle being stolen.

The machine-learning model may be trained using historical data and/or user input to determine that the one or more characteristics and/or actions of the person are indicative of theft. In an example, the machine-learning model may be trained on images and/or video of vehicle break-ins and the circumstances leading up to the break-ins. In an example, the machine-learning model may receive user input corresponding to a user's opinion and/or local standards of characteristics and/or actions indicative of theft. The machine-learning model may prompt the user with a potential scenario in video or text format and receive input from the user on whether the potential scenario is indicative of theft. In this way, the machine-learning model may be customized based on the user's preferences. The user may receive notifications of characteristics and/or actions of persons that correspond to the user's understanding of circumstances indicative of theft.

In response to the person approaching the vehicle, a deterrence action may be executed 230. In some embodiments, image processing may be utilized to detect or otherwise identify 230 the person within a field of view of a camera 110 or image data captured therefrom. In some embodiments, a machine-learning model may be trained and utilized to detect or otherwise identify 210 the person. The deterrence action may include one or more actions to deter theft and/or damage to the vehicle. In an example, a camera executing a machine-learning model may execute the deterrence action based on a determination that the one or more characteristics and/or actions are indicative of theft, and/or a likelihood of the theft. The deterrence action may include actions performed by a variety of devices, such as components of the system 100. In an example, the deterrence action may include turning a porch light on, turning a porch light off, emitting light and/or sounds from a doorbell, emitting light and/or sounds from a camera, turning on sprinklers, turning on or off interior lights, playing a sound on interior and/or exterior speakers, shining a light on the vehicle, or other actions.

The deterrence action may be tailored based on the approach of the person toward the vehicle and/or the one or more characteristics and/or actions of the person. In some implementations, the deterrence action may be based on a direction of the approach. In an example, a person approaching the vehicle from a home associated with the location of the vehicle, such as a driveway of the home will not prompt a deterrence action. In an example, a person approaching the vehicle from a street adjacent the vehicle may prompt a deterrence action. In some implementations, the deterrence action may be tailored based on a speed of the approach. In an example, a more rapid approach may result in a more escalated response.

The deterrence action may include multiple actions and/or a series of actions. The multiple actions may be part of a series of escalating actions to deter theft. In an example, an approach of the person toward the vehicle may prompt the deterrence action of turning a porch light on or flashing the porch light on and off. If the person continues to approach the vehicle, an additional deterrence action may be executed, for example, playing an automated voice telling the person to stop and/or a whistle may be played using a speaker. If the person continues to approach the vehicle, an additional deterrence action may be executed, for example, calling the police, informing the person of the call to the police, and/or turning on sprinklers directed toward the car.

Executing the deterrence action may include emitting one or more audiovisual signals. Executing the deterrence action may include generating, by the computer executing the machine-learning model, the one or more audiovisual signals. The one or more audiovisual signals may include various sounds, automated voices, lights, light patterns, and other audiovisual elements. In an example, the audiovisual signals may include a whistle, recorded phrases, flashing light patterns, and/or a siren.

Executing the deterrence action may include determining an event. In an example, a camera executing a machine-learning model may determine that a person is attempting to open a door of a vehicle. The camera may determine an event in order to select a corresponding deterrence action. In an example, if a mail delivery person passes by a vehicle to deliver mail, no deterrence action is executed. In an example, if a person approaches a vehicle to walk past the vehicle, no deterrence action is taken. In an example, if a person takes actions indicative of theft, such as approaching the vehicle on a trajectory to intercept the vehicle, tries to open the door of the vehicle, or peers into the windows of the vehicle, the camera executes the deterrence action.

Executing the deterrence action may include determining one or more characteristics of the person. The deterrence action may be tailored according to the one or more characteristics of the person. In an example, a deterrence action may be muted or suppressed based on a neighbor or delivery person moving the object. In an example, a deterrence action may be escalated based on a stranger or suspicious person approaching the object. The deterrence action may be based on the one or more characteristics of the person. In an example, an automated voice may reference the one or more characteristics of the person such as their clothing. In an example, an automated voice may say “I see you in the yellow shirt.”

Executing the deterrence action may be based on an identity of the person. In an example, the deterrence action may be escalated based on the person being a known thief or criminal. In an example, the deterrence action may be muted or skipped based on the person being on a list of authorized users of the vehicle. The machine-learning model may learn the list of authorized user of the vehicle based on historical data and/or user input. The machine-learning model may learn known thieves or criminals based on shared security data and/or by accessing police records, or the like.

The machine-learning model may include multiple machine-learning models. The machine-learning model may include multiple machine-learning models which perform different tasks or functions. In an example, the machine-learning model may include a first machine-learning model which identifies vehicles, a second machine-learning model which identifies persons and their characteristics, a third machine-learning model which identifies events, such as an attempted theft, and a fourth machine-learning model which determines deterrence actions. In an example, the machine-learning model includes a first machine-learning model which identifies vehicles, persons, and events, and a second machine-learning which determines deterrence actions. In an example, the machine-learning model includes a first machine-learning model which uses image data from an image sensor and a second machine-learning model which uses radar data from a radar sensor. In an example, the machine-learning model includes a first machine-learning model which uses image data from an image sensor to detect vehicles, a second machine-learning model which uses image data from the image sensor to detect persons, a third machine-learning model which uses radar data from a radar sensor to detect vehicles, and a fourth machine-learning model which uses radar data from a radar sensor to detect persons. The multiple machine-learning models may share data and reinforce each other's decisions and learnings. Other numbers, functions, and combinations of machine-learning models are considered and may be used.

The machine-learning model may be initially trained. In some implementations, the machine-learning model may be initially trained as a standard model and then updated after installation in a specific device to be customized or tailored for use with the specific device (e.g., at a given site, with given sensors or other equipment, etc.). In an example, the machine-learning model may be initially trained as a standard machine-learning model for detecting persons and vehicles, and then updated when installed in a user's camera to be updated and refined based on image data captured by the camera and/or input from the user. In some implementations, the machine-learning model may be initially trained using historical data including a library of video and/or image data. The video and/or image data may include actual and/or synthetic data. In an example, the machine-learning model may be initially trained based on a library of video of vehicle thefts and/or break-ins captured by a plurality of cameras. In an example, the machine-learning model may be initially trained based on a library of video of vehicle thefts and/or break-ins generated by a generative machine-learning model. In some implementations, a central machine-learning model may be centrally trained using image and/or video data from a plurality of cameras and pushed to the plurality of cameras. In some implementations, one or more learnings and/or weights may be centrally obtained and pushed to the plurality of cameras.

The machine-learning model may be updated using historical data and/or user input. The machine-learning model may be updated based on its own observed historical data and/or historical data from other sources. In an example, a camera executing a machine-learning model may update its machine-learning model based on information captured by the camera. In an example, a camera executing a machine-learning model may update its machine-learning model based on information captured by other cameras. In an example, a camera executing a machine-learning model may update its machine-learning model based on learnings received from a server. In an example, a user may identify objects, persons, and other items of interest to update the machine-learning model. In some implementations, the machine-learning model may generate a notification or otherwise notify a user of a potential identification of an object or person and request user input regarding the potential identification. In some implementations, the machine-learning model may be updated based on information from other devices. In an example, the machine-learning model may be updated based on footage of vehicle break-ins to improve an ability of the machine-learning model to identify circumstances, characteristics, and actions indicative of theft. In an example, the machine-learning model may be updated based on information from sensors, such as a proximity sensor, gate sensor, or door sensor. In an example, the machine-learning model may be updated based on learnings identified by other machine-learning models.

An example method may include detecting, by a computer executing a machine-learning model, a vehicle located within an area, detecting, by the computer executing the machine-learning model, a person approaching the vehicle, and in response to the person approaching the vehicle, executing, by the computer executing the machine-learning model, a deterrence action. The computer may be any device or system including a processor and a memory including a non-transitory, computer-readable medium including instructions which, when executed by the processor, cause the processor to execute the functions described herein.

In the example method, detecting the vehicle located within the area may include tracking the vehicle entering the area. In the example method, detecting the vehicle located within the area may include determining that the vehicle is parked. In the example method, detecting the vehicle located within the area may include determining a location of the vehicle using multiple sensors. In the example method, detecting the vehicle located within the area may include identifying the vehicle. In the example method, detecting the vehicle located within the area may include determining a state of the vehicle. In the example method, detecting the person approaching the vehicle may include determining one or more characteristics or actions of the person. In the example method, detecting the person approaching the vehicle may include determining that the one or more characteristics or actions of the person are indicative of theft. In the example method, executing the deterrence action may include emitting one or more audiovisual signals. In the example method, executing the deterrence action may include generating, by the computer executing the machine-learning model, the one or more audiovisual signals.

An example apparatus may include an image sensor, and a processor executing a machine-learning model to detect a vehicle located within an area, detect a person approaching the vehicle, and in response to the person approaching the vehicle execute a deterrence action.

Detecting the vehicle located within the area may include tracking the vehicle entering the area. Detecting the vehicle located within the area may include determining that the vehicle is parked. Detecting the vehicle located within the area may include determining a location of the vehicle using multiple sensors. Detecting the vehicle located within the area may include identifying the vehicle. Detecting the vehicle located within the area may include determining a state of the vehicle. Detecting the person approaching the vehicle may include determining one or more characteristics or actions of the person. Detecting the person approaching the vehicle may include determining that the one or more characteristics or actions of the person are indicative of theft. Executing the deterrence action may include emitting one or more audiovisual signals. Executing the deterrence action may include generating, by the computer executing the machine-learning model, the one or more audiovisual signals.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
detecting, by a computer executing a machine-learning model, a vehicle located within an area;
detecting, by the computer executing the machine-learning model, a person approaching the vehicle; and
in response to the person approaching the vehicle, executing, by the computer executing the machine-learning model, a deterrence action, wherein the machine-learning model is trained by applying the machine-learning model based, at least in part, on historical data including image data of vehicles.

2. The method of claim 1, wherein detecting the vehicle located within the area includes tracking the vehicle entering the area.

3. The method of claim 1, wherein detecting the vehicle located within the area includes determining that the vehicle is parked.

4. The method of claim 1, wherein detecting the vehicle located within the area includes determining a location of the vehicle using multiple sensors.

5. The method of claim 1, wherein detecting the vehicle located within the area includes identifying the vehicle.

6. The method of claim 1, wherein detecting the vehicle located within the area includes determining a state of the vehicle.

7. The method of claim 1, wherein detecting the person approaching the vehicle includes determining one or more characteristics or actions of the person.

8. The method of claim 7, wherein detecting the person approaching the vehicle includes determining that the one or more characteristics or actions of the person are indicative of theft.

9. The method of claim 1, wherein executing the deterrence action includes emitting one or more audiovisual signals.

10. The method of claim 1, wherein executing the deterrence action includes generating, by the computer executing the machine-learning model, one or more audiovisual signals.

11. An apparatus comprising:
an image sensor; and
a processor executing a machine-learning model to:
detect a vehicle located within an area;
detect a person approaching the vehicle; and
in response to the person approaching the vehicle, execute a deterrence action, wherein the machine-learning model is trained by applying the machine-learning model on historical data including image data of vehicles.

12. The apparatus of claim 11, wherein detecting the vehicle located within the area includes tracking the vehicle entering the area.

13. The apparatus of claim 11, wherein detecting the vehicle located within the area includes determining that the vehicle is parked.

14. The apparatus of claim 11, wherein detecting the vehicle located within the area includes determining a location of the vehicle using multiple sensors.

15. The apparatus of claim 11, wherein detecting the vehicle located within the area includes identifying the vehicle.

16. The apparatus of claim 11, wherein detecting the vehicle located within the area includes determining a state of the vehicle.

17. The apparatus of claim 11, wherein detecting the person approaching the vehicle includes determining one or more characteristics or actions of the person.

18. The apparatus of claim 17, wherein detecting the person approaching the vehicle includes determining that the one or more characteristics or actions of the person are indicative of theft.

19. The apparatus of claim 11, wherein executing the deterrence action includes emitting one or more audiovisual signals.

20. The apparatus of claim 11, wherein executing the deterrence action includes generating, by the processor executing the machine-learning model, one or more audiovisual signals.
